(19) United States
(12) Patent Application Publication
(10) Pub. No.: US 2011/0138990 A1
(43) Pub. Date: Jun. 16, 2011

(54) Music Stand Practice Bar

(76) Inventors: Peter John Whitney, Charlotte, NC (US); Sarah Mackenzie Whitney, Charlotte, NC (US)

(21) Appl. No.: 12/895,789

(22) Filed: Sep. 30, 2010

Related U.S. Application Data
(60) Provisional application No. 61/249,314, filed on Oct. 7, 2009.

(51) Int. Cl. G09B 15/00

(52) U.S. Cl. 84/470 R

(57) ABSTRACT

The invention is an apparatus for counting and/or keeping track of one's repetitive practices. For music students, instructed to play a piece of music several times for practice/learning, the Music Stand Practice Bar (invention) helps keep count of the number of times played/practiced. The apparatus can be manufactured in several different configurations. The current configuration shows a solid bar can attach to the front edge tray of a music stand.

### RELATED APPLICATIONS

This application claims benefit to the previously filed provisional patent application No. 61/249,314 filed Oct. 7, 2009. The contents of that application are hereby incorporated by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### BACKGROUND OF INVENTION

The present invention relates to use with music stands while students are practicing to play a musical instrument. We have designed the apparatus to clip onto the front of the music stand's platform. This places the counting beads in front of and below the music.

Music students are typically instructed to practice specific pieces of music in between structured lessons. Music teachers routinely instruct students to play certain pieces of music multiple times. This helps with memorization as well as motor skills and muscle memory. When practicing independently, (and concentrating on reading notes and related numbers) students have a difficult time remembering the number of times they played the piece of music and can either play more than assigned or less.

The present invention incorporates an abacus style apparatus that clips onto the music stands platform. While abacuses have been around for decades if not centuries, they have generally been used for counting only. The present invention incorporates the abacus style apparatus with a music stand to provide an easy reference for students working on repetitive pieces of music.

### SUMMARY OF THE INVENTION

The present invention provides students an intuitive, easy to use, reference for the number of times a piece of music has been played to complete their practice assignment. Music students can simply move a bead after each time they complete the assigned piece of music. Once the desired number has been reached, they can slide all the beads back to one side and begin the next piece of music.

### DESCRIPTION OF THE DRAWINGS

FIG. 1 shows a side view of the invention, as it would approach a music stand.

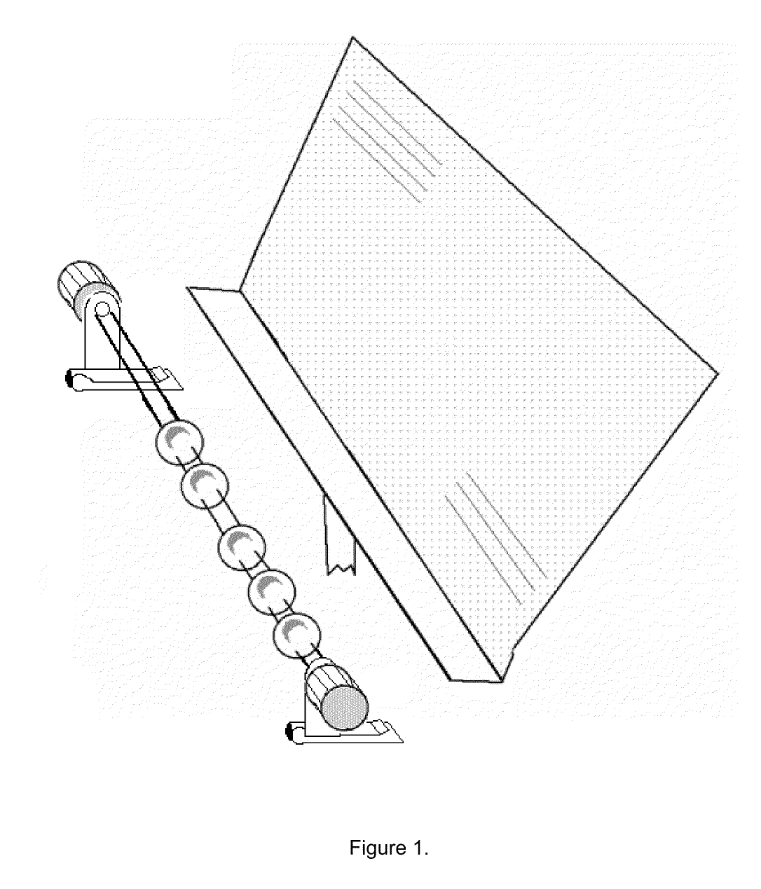

FIG. 2 shows a view from one end, showing the removable cap and clip.

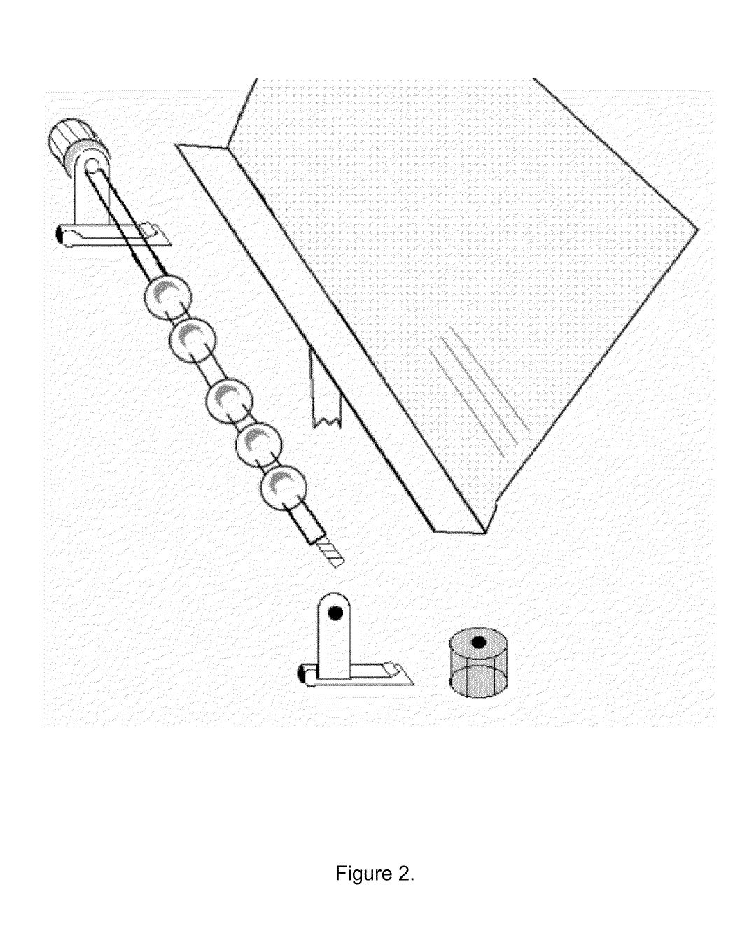

FIG. 3 shows mounting variations with a solid bar.

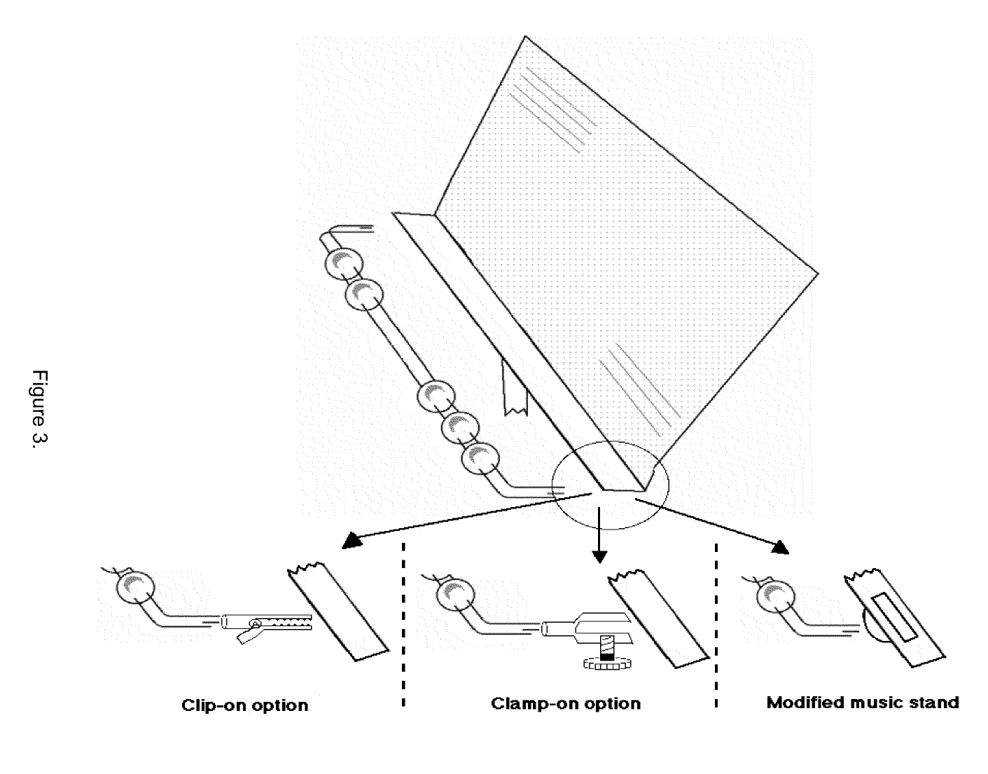

FIG. 4 shows mounting variations with a folding bar.

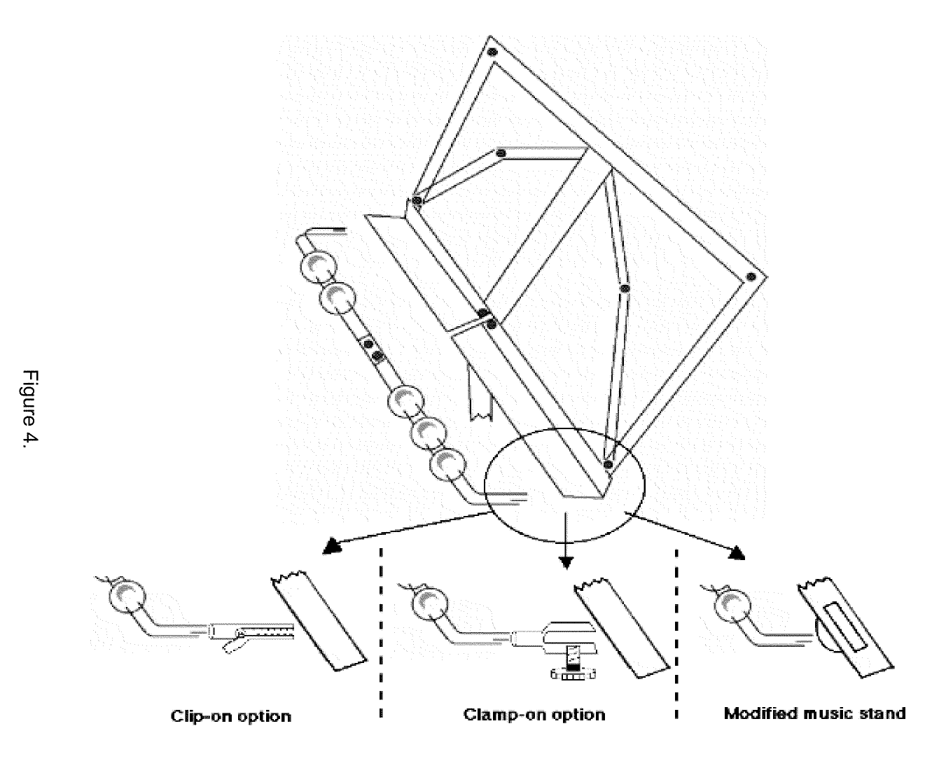

### DETAILED DESCRIPTION OF THE INVENTION

Learning to play an instrument and read music requires a great deal of practice. And, by definition, “practice” is learning by repetition.

Students are given tasks or pieces of music to play, to build skills, muscle control and learning to listen for improved sound.

The proposed music stand practice bar assists students with repetitive practice. As an example: when learning to play the violin, you read music and think of the letters F, A, C, E, G, B, D, F for the strings and 0, 1, 2, 3, 4 for fingers. Additionally, you must pay attention to your grip, finger control, and posture, all while listening to the sounds you produce. After playing a page of music with all the things that require your attention, it can be difficult to remember if you have gone through that piece 6 times or 7 times.

This proposed invention provides an easy to use counting method that does not require additional thought. With the music stand practice bar clipped onto the front of the music stand, the music student simply slides one (1) bead after each piece of music is completed.

The invention is designed to easily clip-on to any music stand with easy sliding beads that can be added to, removed, or changed for color grouping, patterns, numbering, etc.

What is claimed is:

1. A fully assembled music stand practice bar that will clip on to the front edge of a music stand.

2. The music stand practice bar consists of a smooth bar with easy to slide beads.

3. The music stand practice bar has clips on both ends for secure connection to music stands.

4. The music stand practice bar has removable end caps for changing beads.
